(19) United States
(12) Patent Application Publication
(10) Pub. No.: US 2020/0324614 A1
(43) Pub. Date: Oct. 15, 2020

(54) AIR CONDITIONING CONTROL SYSTEM AND AIR CONDITIONING CONTROL METHOD

(71) Applicant: Yazaki Corporation, Tokyo (JP)

(72) Inventor: Ryo Hiramatsu, Makinohara-shi (JP)

(73) Assignee: Yazaki Corporation, Tokyo (JP)

(21) Appl. No.: 16/812,578

(22) Filed: Mar. 9, 2020

(30) Foreign Application Priority Data
Apr. 12, 2019 (JP) 2019-076263

(51) Int. Cl. B60H 1/00; G06K 9/00

(52) U.S. Cl. CPC B60H 1/00207; G06K 9/00201; G06K 9/00838

(57) ABSTRACT

An air conditioning control system includes: an air conditioner that blows wind at a set temperature into an interior of a cabin of a vehicle; an information acquisition unit that acquires distance measurement information inside the cabin from a front reference position in the cabin; a position acquisition unit that acquires a three-dimensional position of a head of a passenger inside the cabin based on the distance measurement information; and a control unit that controls an air blowing direction of the air conditioner based on at least the position acquired by the position acquisition unit.

### TECHNICAL FIELD

The present invention relates to an air conditioning control system and an air conditioning control method for controlling an air blowing direction of an air conditioner mounted on a vehicle.

### BACKGROUND ART

In the air conditioner that is turned on when the passenger feels that the temperature inside the cabin of the vehicle is hot or cold, for example, it is often seen that the air blowing direction is set so as to go to the head position by a passenger's button operation or manual operation. Therefore, a technique for detecting the head position and automatically controlling the air blowing direction of the air conditioner in the direction toward the detected head position has been proposed in order to save the passenger's trouble (for example, refer to Patent Literature 1). In this technique, the head position of the passenger is estimated from a captured image obtained by photographing the interior of the cabin and the seat slide position, and the air blowing direction is controlled in the direction toward the estimated head position.

### PRIOR ART DOCUMENT

### Patent Literature

### Patent Literature 1: JP 2005-112231 A

### SUMMARY OF INVENTION

### Technical Problem

Here, in the above technique, the two-dimensional head position of the passenger is obtained from the two-dimensional photographed image photographed by the cabin camera, and the three-dimensional head position is estimated by adding the seat slide position. However, in such a technique, for example, when the passenger is sitting on the seat in a forward leaning posture, or when the passenger is leaning back with the backrest of the seat tilted backward, there may be a difference between the estimated head position and the actual head position depending on the posture of the passenger. In such a case, the wind from the air conditioner is directed in a direction deviating from the head, and sufficient comfort may not be obtained.

Accordingly, paying attention to the above problem, an object of the present invention is to provide an air conditioning control system and an air conditioning control method capable of appropriately controlling the air blowing direction of the air conditioner so that the passenger can feel sufficient comfort.

### Solution to Problem

In order to solve the above problem, according to a first aspect of the present invention, there is provided an air conditioning control system including:

an air conditioner that blows wind at a set temperature into an interior of a cabin of a vehicle;

an information acquisition unit that acquires distance measurement information inside the cabin from a front reference position in the cabin;

a position acquisition unit that acquires a three-dimensional position of a head of a passenger inside the cabin based on the distance measurement information; and

a control unit that controls an air blowing direction of the air conditioner based on at least the position acquired by the position acquisition unit.

Further, in order to solve the above problem, according to a second aspect of the present invention, there is provided an air conditioning control method including the steps of:

acquiring distance measurement information inside a cabin of a vehicle from a front reference position in the cabin;

acquiring a three-dimensional position of a head of a passenger inside the cabin based on the distance measurement information; and

controlling an air blowing direction of an air conditioner that blows wind at a set temperature into an interior of the cabin based on at least the position acquired by the position acquisition unit.

### Effect of the Invention

According to the air conditioning control system and the air conditioning control method of the present invention, the three-dimensional position of the passenger's head in the interior of the cabin is determined based on the distance measurement information in the interior of the cabin. Therefore, regardless of the posture of the passenger sitting on the seat, the three-dimensional position of the head can be obtained. Then, since the air blowing direction of the air conditioner is controlled based on the position determined in this way, the air blowing direction of the air conditioner can be appropriately controlled so that the passenger can feel sufficient comfort.

### BRIEF DESCRIPTION OF DRAWINGS

FIG. 1 is a schematic diagram showing an embodiment of an air conditioning control system;

FIG. 2 is a schematic block diagram of the air conditioning control system shown in FIG. 1;

FIG. 3 is a flowchart showing a process flow in an air conditioning control method executed by the air conditioning control system shown in FIGS. 1 and 2; and

FIG. 4 is a schematic diagram showing an example of a state inside a cabin when the air conditioning control method is executed according to the flowchart shown in FIG. 3.

### DESCRIPTION OF EMBODIMENTS

Hereinafter, an embodiment of an air conditioning control system and an air conditioning control method will be described.

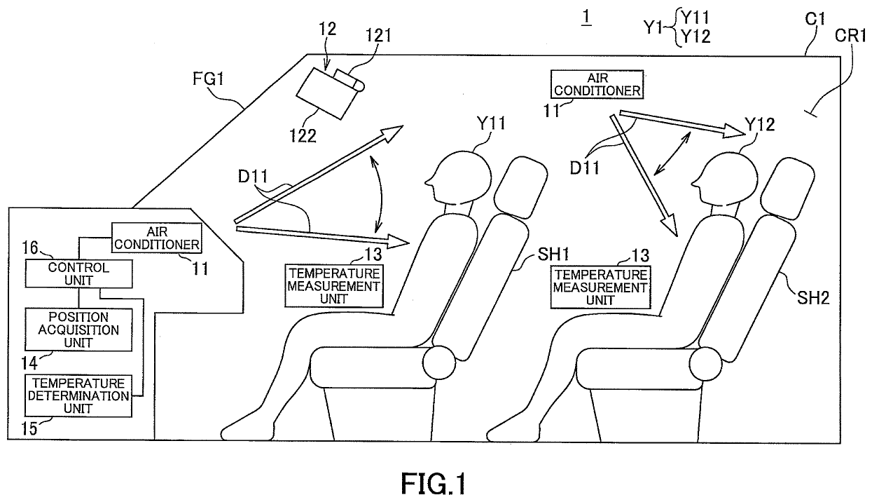

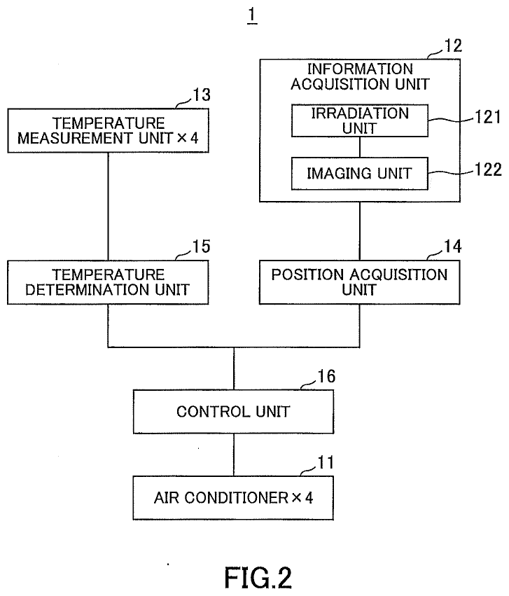

FIG. 1 is a schematic diagram showing an embodiment of an air conditioning control system, and FIG. 2 is a schematic block diagram of the air conditioning control system shown in FIG. 1.

An air conditioning control system 1 in the present embodiment controls an air blowing direction D11 of an air conditioner 11 installed in a cabin CR1 of a vehicle C1. This air conditioning control system 1 includes the air conditioner 11, an information acquisition unit 12, a temperature measurement unit 13, a position acquisition unit 14, a temperature determination unit 15, and a control unit 16.

The air conditioner 11 is a device that blows wind at a preset temperature into an interior of the cabin CR1 in the vehicle C1, and installed at four places in total, two places on a front seat SH1 side and two locations on a rear seat SH2 side of the cabin CR1. The air conditioner 11 on the front seat SH1 side is built in an instrument panel in front of the front seat SH1 so that each air outlet faces a front seat passenger Y11 sitting on the front seat SH1. The air conditioner 11 on the rear seat SH2 side is attached to on a ceiling of the rear seat SH2 side in the cabin CR1 so that each air outlet faces a rear passenger Y12 sitting on the rear seat SH2.

The information acquisition unit 12 acquires distance measurement information inside the cabin CR1 from a front reference position in the cabin CR1. Specifically, the information acquisition unit 12 is an imaging device that captures the cabin CR1 and obtains a three-dimensional captured image that also represents a distance to an object within an imaging range of the cabin CR1. As such an imaging device, although not specified here, a conventionally known camera having a distance measuring function such as a stereo camera or a TOF (Time-of-Flight) camera can be employed as an example.

In addition, the imaging device as the information acquisition unit 12 includes an irradiation unit 121 that emits infrared light and an imaging unit 122 that can photograph an image of an infrared region so that shooting can be performed even when the cabin CR1 is dark. The imaging unit 122 is installed in the vicinity of an upper edge of a windshield FG1 so that both the front seat passenger Y11 sitting in the front seat SH1 and the rear seat passenger Y12 sitting in the rear seat SH2 are in the imaging range. This installation position corresponds to a front installation position in the present embodiment. Then, the irradiation unit 121 is attached to this imaging unit 122 so that the imaging range of the imaging unit 122 can fully be covered.

The temperature measurement unit 13 is a sensor that measures the temperature of the cabin CR1, and is installed at four places in total, two places on the front seat SH1 side and two places on the rear seat SH2 side of the cabin CR1.

The position acquisition unit 14 obtains the three-dimensional positions of the heads of the passengers Y1 of the front seat SH1 and the rear seat SH2 inside the cabin CR1 based on the distance measurement information acquired by the information acquisition unit 12.

The temperature determination unit 15 determines whether the temperature difference between the set temperature in each of the four air conditioners 11 and the temperature measurement result in the temperature measurement unit 13 located in the vicinity of each air conditioner 11 is equal to or greater than a predetermined threshold value or not.

For each of the four air conditioners 11, the control unit 16 controls the air blowing direction D11 of the air conditioner 11 based on the head position of the passenger Y1 acquired by the position acquisition unit 14 and the determination result by the temperature determination unit 15. That is, for each seat, the control unit 16 controls the air blowing direction D11 based on whether the temperature difference between the set temperature of the air conditioner 11 and the temperature measurement result in the vicinity thereof is equal to or greater than a predetermined threshold value or not, and the head position of the passenger Y1 acquired by the position acquisition unit 14. Specifically, the control unit 16 controls the air blowing direction D11 in a direction toward the head position of the passenger Y1 acquired by the position acquisition unit 14, when it is determined that the temperature difference is equal to or greater than the threshold value. Moreover, the control part 16 controls the air blowing direction D11 in a direction which avoiding the head position of the passenger Y1, when it is determined that the temperature difference is smaller than the threshold value. Further, in the present embodiment, after the control unit 16 controls the air blowing direction D11 in the direction toward the head position, when a predetermined time has elapsed, the control unit 16 controls the air blowing direction D11 in a direction avoiding the head position.

Among the components of the air conditioning control system 1 described above, the position acquisition unit 14, the temperature determination unit 15, and the control unit 16 are functional blocks constructed in an ECU (Electronic Control Unit) mounted on the vehicle C1.

Next, an air conditioning control method executed in the air conditioning control system 1 will be described.

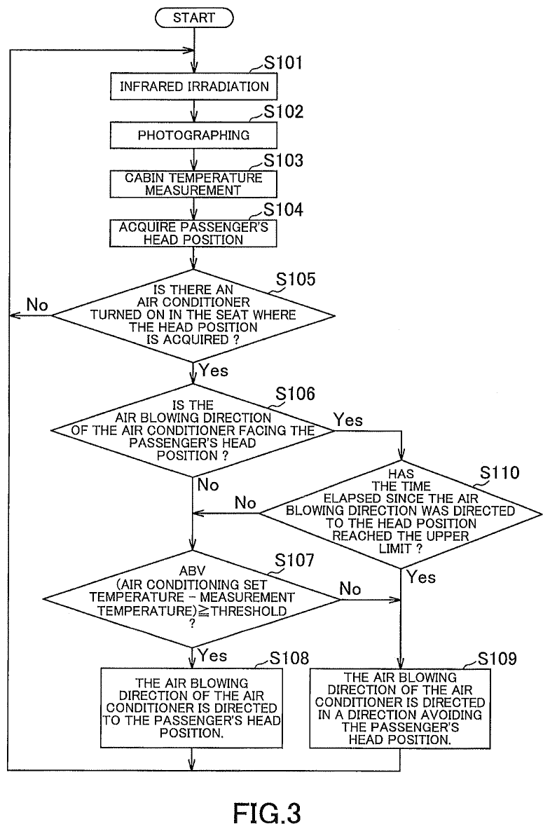

FIG. 3 is a flowchart showing a process flow in the air conditioning control method executed by the air conditioning control system shown in FIGS. 1 and 2.

This air conditioning control method shown in FIG. 3 starts when power is turned on to the ECU of the vehicle C1. When the processing starts, infrared irradiation (step S101) by the irradiation unit 121 of the information acquisition unit 12, photographing by the imaging unit 122 under the irradiation (step S102), and temperature measurement by the temperature measurement unit 13 (step S103) are executed. The processes of steps S101 and S102 correspond to an example of the information acquisition step of acquiring distance measurement information inside the cabin CR1 from the front reference position in the cabin CR1. Further, the process of step S103 corresponds to an example of a temperature measurement process for measuring the temperature inside the cabin CR1.

Next, the three-dimensional position of the head of the passenger Y1 inside the cabin CR1 is acquired based on the three-dimensional photographed image that also represents the distance to the object within the photographing range as the distance measurement information obtained by the information obtaining unit 12 (step S104). This process in step S104 corresponds to an example of the position acquisition step for acquiring a three-dimensional position of the head of the passenger Y1 inside the cabin CR1 based on the distance measurement information.

Then, the control unit 16 determines whether or not there is a seat in which the head position of the passenger Y1 is acquired and the corresponding air conditioner 11 is powered on and turned on among a total of four seats, two front seats SH11 and two rear seats SH12 (step S105).

When there is no seat where the head position was acquired and the air conditioner 11 is turned on (No determination in step S105), the process returns to step S101 and the subsequent processes are repeated. On the other hand, when there is even one seat where the head position is acquired and the air conditioner 11 is turned on (Yes determination in step S105), the subsequent processing is performed for the air conditioner 11 of this seat.

First, the control unit 16 determines whether or not the air blowing direction D11 of the air conditioner 11 in the on state is facing the head position acquired for the passenger Y1 sitting in the seat corresponding to the air conditioner 11. (Step S106). When the air blowing direction D11 does not face the head position (No determination in step S106), the next determination is performed by the temperature determination unit 15 (step S107). That is, in step S107, it is determined whether or not the temperature difference between the set temperature of the air conditioner 11 and the temperature measurement result in the temperature measurement unit 13 near the seat corresponding to the air conditioner 11 is equal to or greater than a predetermined threshold value.

When the temperature difference is equal to or larger than the threshold value (Yes determination in step S107), the air blowing direction D11 of the air conditioner 11 is controlled by the control unit 16 to be directed to the head position acquired for the passenger Y1 sitting on the seat corresponding to the air conditioner 11 (step S108). On the other hand, when the temperature difference is smaller than the threshold value (No determination in step S107), the direction is controlled by the control unit 16 so as to avoid the head position of the passenger Y1 (step S109). When the determination in step S106 is No and the process reaches step S109, the air blowing direction D11 that has not been directed to the head position is maintained as it is.

Here, in step S106 described above, when it is determined that the air blowing direction D11 of the air conditioner 11 faces the head position (Yes determination in step S106), the following processing is performed for the elapsed time since the air blowing direction D11 is directed to the head position. That is, the control unit 16 determines whether or not the elapsed time has reached a predetermined upper limit time (step S110). If the elapsed time has not yet reached the upper limit time (No determination in step S110), the process proceeds to step S107, and a determination is made regarding the temperature difference between the set temperature of the air conditioner 11 and the temperature measurement result. If the temperature difference is greater than or equal to the threshold value, the process proceeds to step S108, and the air blowing direction D11 that has been facing the head position is maintained as it is. On the other hand, if the temperature difference is smaller than the threshold value, the process proceeds to step S109, where the air blowing direction D11 that faces the head position is controlled by the control unit 16 so as to face a direction avoiding the head position.

Also, when the elapsed time since the air blowing direction D11 is directed to the head position has reached the upper limit time (Yes determination in step S110), the process proceeds to step S109, and the air blowing direction D11 is controlled by the control unit 16 so as to face the direction avoiding the head position.

The process of step S107 corresponds to an example of a temperature determination step of determining whether or not the temperature difference between the set temperature in the air conditioner 11 and the temperature measurement result in the temperature measurement unit 13 is equal to or greater than a predetermined threshold value. Then, the processing of steps S108 to S110 corresponds to an example of a control process for controlling the air blowing direction D11 of the air conditioner 11 based on the acquired head position of the passenger Y1.

When the process of step S108 or step S109 is executed, the process returns to step S101 and the subsequent processes are repeated.

The process of the flowchart shown in FIG. 3 is repeatedly executed until the power source of the ECU of the vehicle C1 is shut off.

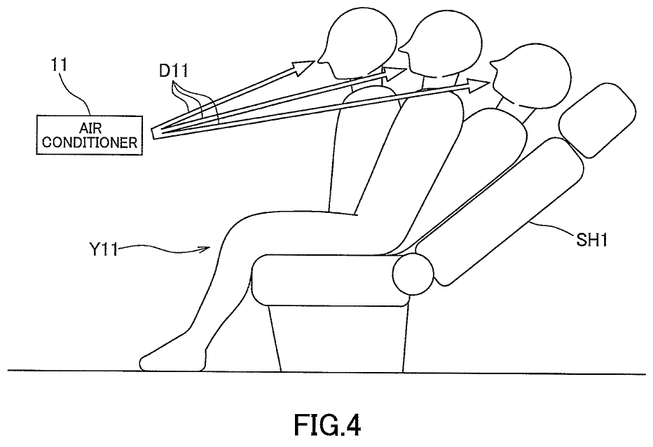

FIG. 4 is a schematic diagram showing an example of a state inside a cabin when the air conditioning control method is executed according to the flowchart shown in FIG. 3.

FIG. 4 shows a state in which the air blowing direction D11 of the air conditioner 11 corresponding to the front seat SH11 is controlled, taking the front seat passenger Y11 sitting in the front seat SH1 as an example. The example of FIG. 4 is an example in which the temperature difference between the set temperature of the air conditioner 11 and the temperature measurement result is equal to or greater than the threshold value, and the air blowing direction D11 is controlled to face the head position of the front seat passenger Y11. In this example, the air blowing direction D11 of the air conditioner 11 is controlled in accordance with various postures such as a forward leaning posture and a posture of lying on the back when the backrest is tilted backward. As schematically shown in FIG. 4, in the case of the forward leaning posture, the head position is positioned forward and slightly upward, and the air blowing direction D11 is controlled in a direction slightly upward following the head position. Then, as the front seat passenger Y11 is getting on its back, it is controlled in the downward direction so as to follow the position of the head that falls backward and slightly downward.

On the other hand, although illustration is omitted, when the above temperature difference is smaller than the threshold value or when the elapsed time after the air blowing direction D11 is directed to the head position reaches the upper limit time, the air blowing direction D11 is controlled so as to avoid the head position.

According to the air conditioning control system 1 and the air conditioning control method of the embodiment described above, the three-dimensional position of the head of the passenger Y1 inside the cabin CR1 is determined based on the distance measurement information inside the cabin CR1. Therefore, no matter what posture the passenger Y1 is sitting on the seat, the three-dimensional position of the head can be acquired regardless of the posture. Then, since the air blowing direction D11 of the air conditioner 11 is controlled based on the position acquired in this way, the air blowing direction D11 of the air conditioner 11 is appropriately controlled so that passenger Y1 can feel sufficient comfort.

Here, according to the present embodiment, the air blowing direction D11 is also controlled based on the temperature difference between the set temperature in the air conditioner 11 and the temperature measurement result of the temperature of the cabin CR1. Therefore, the air blowing direction D11 of the air conditioner 11 can be controlled so that the passenger Y1 can feel further comfort.

Specifically, when the temperature difference is determined to be greater than or equal to the threshold value, the air blowing direction D11 is controlled in the direction toward the head position, and when the temperature difference is determined to be smaller than the threshold value, the air blowing direction D11 is controlled in a direction avoiding the head position.

According to such control, when it is assumed that the temperature difference is large and the passenger Y1 seeks cooling or warming, the air blowing direction D11 is controlled in the direction toward the head position, and in other cases is controlled in a direction avoiding the head position. Such control can make the passenger Y1 feel more comfortable.

Further, according to the present embodiment, after a sufficient amount of time has elapsed after the air blowing direction D11 is directed to the head position of the passenger Y1, the air blowing direction D11 is controlled in a direction avoiding the head position. By such control, it is possible to avoid such a situation that the passenger Y1 is uncomfortable due to excessive air blowing to the head position after the lapse of time.

Further, according to the present embodiment, since the distance measurement information is captured as a captured image, the head position of the passenger Y1 can be acquired more accurately.

In addition, according to the present embodiment, even when the cabin CR1 is dark, an image in the infrared region is captured, so that the head position of the passenger Y1 can be obtained more accurately.

The embodiment described above is merely a representative form of the air conditioning control system and the air conditioning control method, and the air conditioning control system and the air conditioning control method are not limited to this and can be implemented with various modifications.

For example, in the above-described embodiment, the air-conditioning control system 1 is exemplified in which the air conditioners 11 are arranged in the four places within the instrument panel and on the ceiling of the cabin CR1, and the temperature measurement units 13 are provided in four places in total at two locations on the front seat SH1 side and at two locations on the rear seat SH2 side. Further, as for the information acquisition unit, the information acquisition unit 12 is exemplified in which the imaging unit 122 is installed with the vicinity of the upper edge of the windshield FG1 as the front reference position, and the irradiation unit 121 is attached to the imaging unit 122. However, the installation positions of these components are not limited to the installation positions of the above-described embodiment. As long as the position satisfies the performance required for each component, the specific installation position is not questioned.

Further, in the above-described embodiment, the position acquisition unit 14, the temperature determination unit 15, and the control unit 16 constructed in the ECU mounted on the vehicle C1 are exemplified. However, the construction location of these components is not limited to the ECU, and may be a computer device or the like mounted on the vehicle C1 separately from the ECU.

Further, in the above-described embodiment, the air conditioning control system 1 and the air conditioning control method are exemplified in which the temperature of the cabin CR1 is measured, and it is determined whether or not the temperature difference between the set temperature in the air conditioner 11 and the temperature measurement result is equal to or greater than a predetermined threshold value. The air blowing direction D11 is controlled based on the determination result about a temperature difference in addition to the head position of the passenger Y1. Specifically, when the temperature difference is equal to or larger than the threshold value, the air blowing direction D11 is directed to the head position, and when the temperature difference is smaller than the threshold value, the air blowing direction D11 is directed to a direction avoiding the head position. However, the air conditioning control system and the air conditioning control method are not limited to this, and the air blowing direction D11 may be controlled based only on the head position of the passenger Y1. However, as described above, it is possible to make the passenger Y1 feel more comfortable by controlling the air blowing direction D11 based on the determination result of the temperature difference.

Further, in the above-described embodiment, the air conditioning control system 1 and the air conditioning control method are exemplified that controls the air blowing direction D11 in a direction avoiding the head position when a predetermined time has elapsed after controlling the air blowing direction D11 in the direction toward the head position. However, the air conditioning control system and the air conditioning control method are not limited to this, and may control such that the air blowing direction D11 is always directed to the head position of the passenger Y1. However, as described above, it is possible to make the passenger Y1 feel more comfortable by controlling the air blowing direction D11 to change based on the elapsed time after the air blowing direction D11 is directed to the head position.

Further, In the above-described embodiment, the air conditioning control system 1 and the air conditioning control method are exemplified for obtaining a captured image that also represents the distance to the object within the imaging range as distance measurement information inside the cabin CR1. However, the air conditioning control system and the air conditioning control method are not limited to this, and may be one that obtains distance measurement information as simple distance data instead of an image. However, as described above, the head position of the passenger Y11 can be acquired more accurately by obtaining a captured image as information representing the distance.

Moreover, in embodiment mentioned above, the air conditioning control system 1 and the air conditioning control method are exemplified in which infrared rays are irradiated and the image of an infrared region is photographed. However, the air conditioning control system and the air conditioning control method are not limited to this, and only an image in the visible light region may be taken. However, as described above, it is possible to acquire the head position of the passenger Y11 more accurately by capturing an image in the infrared region even when the passenger compartment is dark.

### REFERENCE SIGNS LIST

1 Air conditioning control system
11 Air conditioner
12 Information acquisition unit
13 Temperature measurement unit
14 Position acquisition unit
15 Temperature determination unit
16 Control unit
121 Irradiation unit
122 Imaging unit
C1 Vehicle
CR1 Cabin
SH1 Front seat
SH2 Rear seat
Y1 Passenger
Y11 Front seat passenger
Y12 Rear seat passenger
D11 Air blowing direction

1. An air conditioning control system comprising:
an air conditioner that blows wind at a set temperature into an interior of a cabin of a vehicle;
an information acquisition unit that acquires distance measurement information inside the cabin from a front reference position in the cabin;
a position acquisition unit that acquires a three-dimensional position of a head of a passenger inside the cabin based on the distance measurement information; and
a control unit that controls an air blowing direction of the air conditioner based on at least the position acquired by the position acquisition unit.

2. The air conditioning control system as claimed in claim 1 further comprising:
a temperature measuring unit that measures a temperature of the cabin; and
a temperature determination unit that determines whether a temperature difference between the set temperature and a temperature measurement result in the air conditioner is equal to or greater than a predetermined threshold value,
wherein the control unit controls the air blowing direction based on a determination result by the temperature determination unit in addition to the position acquired by the position acquisition unit.

3. The air conditioning control system as claimed in claim 2,
wherein when the temperature determination unit determines that the temperature difference is equal to or greater than the threshold value, the control unit controls the air blowing direction in a direction toward the position acquired by the position acquisition unit, and when the temperature determination unit determines that the temperature difference is smaller than the threshold value, the control unit controls the air blowing direction in a direction avoiding the position.

4. The air conditioning control system as claimed in claim 1,
wherein after the control unit controls the air blowing direction in the direction toward the position acquired by the position acquisition unit, when a predetermined time has elapsed, the control unit controls the air blowing direction in a direction avoiding the position.

5. The air conditioning control system as claimed in claim 2,
wherein after the control unit controls the air blowing direction in the direction toward the position acquired by the position acquisition unit, when a predetermined time has elapsed, the control unit controls the air blowing direction in a direction avoiding the position.

6. The air conditioning control system as claimed in claim 3,
wherein after the control unit controls the air blowing direction in the direction toward the position acquired by the position acquisition unit, when a predetermined time has elapsed, the control unit controls the air blowing direction in a direction avoiding the position.

7. The air conditioning control system as claimed in claim 1,
wherein the information acquisition unit is an imaging device that photographs the cabin and obtains a captured image that also represents a distance to an object within a photographing range of the cabin.

8. The air conditioning control system as claimed in claim 2,
wherein the information acquisition unit is an imaging device that photographs the cabin and obtains a captured image that also represents a distance to an object within a photographing range of the cabin.

9. The air conditioning control system as claimed in claim 3,
wherein the information acquisition unit is an imaging device that photographs the cabin and obtains a captured image that also represents a distance to an object within a photographing range of the cabin.

10. The air conditioning control system as claimed in claim 4,
wherein the information acquisition unit is an imaging device that photographs the cabin and obtains a captured image that also represents a distance to an object within a photographing range of the cabin.

11. The air conditioning control system as claimed in claim 5,
wherein the information acquisition unit is an imaging device that photographs the cabin and obtains a captured image that also represents a distance to an object within a photographing range of the cabin.

12. The air conditioning control system as claimed in claim 6,
wherein the information acquisition unit is an imaging device that photographs the cabin and obtains a captured image that also represents a distance to an object within a photographing range of the cabin.

13. The air conditioning control system as claimed in claim 7,
wherein the imaging device includes:
an irradiation unit that emits infrared rays; and
an imaging unit that can photograph images in an infrared region.

14. The air conditioning control system as claimed in claim 8,
wherein the imaging device includes:
an irradiation unit that emits infrared rays; and
an imaging unit that can photograph images in an infrared region.

15. The air conditioning control system as claimed in claim 9,
wherein the imaging device includes:
an irradiation unit that emits infrared rays; and
an imaging unit that can photograph images in an infrared region.

16. The air conditioning control system as claimed in claim 10,
wherein the imaging device includes:
an irradiation unit that emits infrared rays; and
an imaging unit that can photograph images in an infrared region.

17. The air conditioning control system as claimed in claim 11,
wherein the imaging device includes:
an irradiation unit that emits infrared rays; and
an imaging unit that can photograph images in an infrared region.

18. The air conditioning control system as claimed in claim 12,
wherein the imaging device includes:
an irradiation unit that emits infrared rays; and
an imaging unit that can photograph images in an infrared region.

19. An air conditioning control method comprising the steps of:
acquiring distance measurement information inside a cabin of a vehicle from a front reference position in the cabin;
acquiring a three-dimensional position of a head of a passenger inside the cabin based on the distance measurement information; and
controlling an air blowing direction of an air conditioner that blows wind at a set temperature into an interior of the cabin based on at least the position acquired by the position acquisition unit.
